(19) United States
(12) Patent Application Publication
(10) Pub. No.: US 2012/0088016 A1
(43) Pub. Date: Apr. 12, 2012

(54) COMPOSITION FOR REDUCING BAKING LOSSES

(75) Inventors: Jens Pillings, Dortmund (DE); Walid Banafa, Berlin (DE)

(73) Assignee: Bayer CropScience AG, Monheim am Rhein (DE)

(21) Appl. No.: 12/301,817

(22) PCT Filed: May 21, 2007
(86) PCT No.: PCT/EP2007/004650

§ 371 Date: Nov. 21, 2008

Related U.S. Application Data
(60) Provisional application No. 60/808,337, filed on May 25, 2006.

(30) Foreign Application Priority Data
May 24, 2006 (EP) EP 06090088.3

(51) Int. Cl. A21D 2/18

(52) U.S. Cl. 426/331; 426/549

(57) ABSTRACT

The present invention relates to a composition for reducing baking losses, combination of modified wheat flour and at least one baking agent conventional in baking processes being used.

The present invention relates to a composition for reducing baking losses, a combination of wheat flour and at least one baking agent conventional in baking processes being used.

The quality of baked goods is affected by a plurality of factors: the raw materials and formulas; dough standing time, working and also fermentation and baking conditions.

The choice of wheat cultivar has a great effect on the features of baking quality such as protein content and wet-gluten content, baking volume and sedimentation value.

Those skilled in the art take baking loss (also known as final baking loss) to be the weight loss of the dough or dough pieces during baking. Primarily it is evaporating dough water and also to a minimal extent other volatile components such as alcohol, organic acids and esters; therefore, those skilled in the art can also speak of “water loss”.

The baking loss proceeds in parallel to the temperature course in the dough piece during baking, that is to say it is greatest in the edge regions (crust), because the highest temperature prevails there. In addition, the baking loss is greatly dependent on the baked product size or baked product surface area. Relatively small baked products have a higher baking loss in percentage terms than larger baked products. In addition to the size and shape of the bakery product, other factors also have an influence: that is to say dough processing and dough standing, the crust fraction baking time and over temperature.

The average baking losses for small bakery products are 18-22%, in the case of 1000 g bread 13%, and in the case of 2000 g bread 11%.

High baking losses have a disadvantageous effect on the baked product yield of the baker and thus on the weight and also the number of baked goods to be sold.

In addition, the water losses during the baking process have a disadvantageous effect on the freshness of the baked goods which thereby age earlier, that is become stale.

This in turn impairs the flavor of the baked goods and thus what is termed “mouth feel”.

In baking processes, the addition of baking agents is a conventional procedure. Those skilled in the art take baking agents to mean all substances which (are to) improve the volume, yield, flavor, freshness retention and/or dough processing.

Conventional baking agents are, for example, xanthan, carboxymethyl cellulose (CMC), guar seed meal, pectins, carob bean meal, emulsifiers or soy flour.

The use of baking agents gives rise to additional costs and in most cases requires a more or less complex adaptation of the dough processing and baking processes. In contrast, reducing the baking losses, however, is not always high enough that in the long term the use of the baking agent is economically rational.

Therefore, there is a great requirement for compositions and uses which reduce the baking losses on production of bakery products and give rise to properties such as improved flavor and improved mouth feel, and also increase the baking yield of the baker.

The present invention relates to a composition which comprises wheat flour having a phosphate content of at least 2 μmol of C-6-P/g of starch in combination with at least one baking agent in an amount which reduces the baking losses more greatly than compositions which comprise wheat flour having a phosphate content of less than 2 μmol of C-6-P/g of starch.

In a preferred embodiment, the composition according to the invention comprises wheat flour having a phosphate content of at least 2 μmol of C-6-P/g of starch in combination with at least one baking agent in an amount which reduces baking loss synergistically.

Surprisingly, it has been found in the present invention that by using wheat flour having a phosphate content of at least 2 μmol of C-6-P/g of starch in combination with a baking agent a synergistic effect is achieved. This synergistic effect gives rise to a significantly greater reduction in baking losses, that is the action of this composition is greater than the action of the individual components.

The individual components in the context of the present invention are taken to mean the following: one component comprises a flour having a phosphate content of at least 2 μmol of C-6-P/g of starch; the other component the respective baking agent together with an unmodified one, since a baked good cannot be produced from the baking agent alone.

The term “phosphate content” in the context of the present invention is to be taken to mean the content of phosphate groups which are bound to carbon atom position “6” of the glucose monomers of the flour. In principle, in the starch, in vivo positions C2, C3 and C6 of the glucose units can be phosphorylated. The phosphate content in the C6 position (=C-6-P content), in the context of the present invention, is determined via glucose-6-phosphate determination by means of the optical-enzymatic test described hereinafter (according to Nielsen et al., 1994, Plant Physiol. 105, 111-117).

The expression “phosphate content of at least 2 μmol of C-6-P/g of starch”, in the context of the present invention, means that the content of phosphate groups which are bound to carbon atom position “6” of the glucose monomers is at least 2 μmol per gram of starch.

In a further embodiment, the flour used is modified in such a manner that the phosphate content is at least 2 μmol of C-6-phosphate/g of starch. In a preferred embodiment, the flour has a content of 2 to 10 μmol of C-6-phosphate/g of starch, particularly preferably 2 to 8 μmol of C-6-phosphate/g of starch, and very particularly preferably 4 to 6 μmol of C-6-phosphate/g of starch.

The phosphate content of wheat flour can be modified by various processes, this can proceed, for example, by genetic modification of the wheat plant or by means of chemical phosphorylation of the extracted starch.

In a preferred embodiment, the wheat flour underlying the invention is modified. In a particularly preferred embodiment, the wheat flour underlying the invention is genetically modified. In the context of the present invention, “genetically modified wheat flour” means that the wheat flour originates from grains of a genetically modified wheat plant, its genetic modification leading to increase of the phosphate content of the starch, compared with the phosphate content of a corresponding non-genetically modified wheat plant. In non-modified wheat flour, phosphate is not detectable at all in the starch, or merely in traces.

In a further preferred embodiment, use was made of wheat plants which express an R1 gene (alpha-glucan water dikinase, E.C.2.7.9.4; Lorberth et al. (1998) Nature Biotechnology 16: 473-477) from potatoes (Solanum tuberosum). The nucleotide and amino acid sequences are reported in Seq ID No.1 and Seq ID No.2. Production of these plants is extensively described in the patent application WO 02/34923 (examples 1 and 2).

In a further preferred embodiment, the starch of the wheat flour underlying the invention was phosphorylated by chemical agents; this phosphorylation gave rise to an increase in the phosphate content compared with the phosphate content of a corresponding wheat plant which was not chemically phosphorylated.

In a preferred embodiment, use is made of baking agents from the group (but not restricted thereto) xanthan, carboxymethyl cellulose, pectin, emulsifiers, carob bean meal, guar seed meal or soy flour.

A preferred composition according to the invention comprises wheat flour having at least 2 μmol of C-6-phosphate/g of starch and also the baking agent xanthan. Xanthan (E415) is a naturally occurring polysaccharide which is produced in a biotechnological process using fermentation of glucose or sucrose by the bacterium Xanthomonas campestris. It is useable in versatile ways, for instance as thickener and stabilizer in the food and building material industries, and also for emulsions in paints and cosmetics. In the food industry it is also used as gluten substitute inter alia in yeast baked goods. Sidhu and Bawa 2002 (Int. Journal of Food Properties 5(1): 1-11) describe that the addition of 0.2% xanthan to wheat flour increased the water absorption from 59 to 60.8%, and the addition of 0.5% xanthan increased it to 62%.

In this context, the ratio of the individual components can be varied to one another in a relatively large range. Preferably, the amount of xanthan added to the flour is between 0.01 to 2%, in particular 0.1 to 1%, and particularly preferably between 0.1 to 0.5%.

A further preferred composition according to the invention comprises wheat flour having at least 2 μmol of C-6-phosphate/g of starch and also the baking agent carboxymethyl cellulose. Carboxymethyl cellulose (=CMC; E466), structurally, is chemically modified crystals of plant fibers, that is to say cellulose treated with lyes or chloroacetic acid. CMC is used, inter alia, as gelling agent and thickener and also water retention system and thus serves to prolong the time foods are fresh. Sidhu and Bawa (2000, Int. Journal of Food Properties, 3(3): 407-419), at an addition of 0.1 to 0.5% CMC to the wheat flour, observed an increase in water absorption from 1.4 to 8.6% compared to the control. The specific volume and the additional yield increased by 0.7 to 3.3%, the yields which were above 1% being achieved for the addition of >0.3% CMC, but, according to the authors, this was accompanied with decreasing bread quality (“slightly gummy”).

In this context, the ratio of the individual components to one another can be varied within a relatively large range. Preferably, the amount of carboxymethyl cellulose added to the flour is between 0.1 and 2%, in particular 0.1 and 1%, and particularly preferably between 0.2 and 0.5%.

A further preferred composition according to the invention comprises wheat flour having at least 2 μmol of C-6-phosphate/g of starch and also the baking agent pectin.

Pectins (E440) are polysaccharides which are obtained from plants (apple pomace, beet cossettes, citrus peel) and are used as gelling agents, and also as bulk fiber. Yaseen et al. (2001, Polish J. of Food and Nutrition Sc. 10/51 (4): 19-25) describe the effect of pectins as antistaling agents of bread. According to their studies, the addition of 1-2% pectin reduced the baking losses by 1-1.5%, a fraction of >1.5% pectin rather having an adverse effect on volume and stability of the breads.

In this context, the ratio of the individual components to one another can be varied within a relatively large range. Preferably, the amount of pectin added to the flour is between 0.1 and 1.5%, in particular between 0.1 and 1.0%, and particularly preferably between 0.2 and 0.5%.

A further preferred composition according to the invention comprises wheat flour having at least 2 μmol of C-6-phosphate/g of starch and also an emulsifier as baking agent.

Emulsifiers are substances which make it possible to bring into a lasting emulsion components which are actually not miscible with one another. Emulsifiers are distinguished by being soluble in water and also in fat. The molecules of an emulsifier comprise two parts, a lipophilic part and a hydrophobic part. Thus they can stabilize the interfacial boundaries between two actually incompatible substances such as fat and water.

Emulsifiers occur in nature principally in animal or vegetable fats and oils, for example lecithin (from soybean). They are also produced industrially, for example DATEM (diacetyltartaric esters) and SSL (sodium stearoyl-2-lactylate). The emulsifiers are used in the food industry for stabilizing mixed systems. They are used for production of bakery products in order to improve the kneading and fermentation stability of doughs and to achieve in bread a greater volume and softer crumb.

In this context, the ratio of the individual components to one another can be varied in a relatively large range. Preferably, the amount of emulsifiers added to the flour is between 0.1 and 2%, in particular between 0.2 and 1.0%, and particularly preferably between 0.3 and 0.5%.

A further composition preferred according to the invention comprises wheat flour having at least 2 μmol of C-6-phosphate/g of starch and also the baking agent carob bean meal.

Carob bean meal is obtained by milling the endosperm of ripe seeds of the carob tree (Ceratonia siliqua). Over 90% of the flour comprises polysaccharides, including the galactomannan carubin. The polysaccharides can bind large amounts of water and are therefore also used in the medical sector.

In this context, the ratio of the individual components to one another can be varied within a relatively large range. Preferably the amount of carob bean meal added to the flour is between 0.1 and 2%, in particular between 0.3 and 1.5%, and particularly preferably between 0.5 and 1%.

A further composition preferred according to the invention comprises wheat flour having at least 2 μmol of C-6-phosphate/g of starch and also the baking agent guar seed meal.

Guar seed meal is obtained from the seeds of the Indian cluster bean. It has a high water binding capacity and is therefore also used for diabetic applications.

In this context, the ratio of the individual components to one another can be varied within a relatively large range. Preferably, the amount of guar seed meal added to the flour is between 0.1 and 2%, in particular between 0.3 and 1.5%, and particularly preferably between 0.5 and 1%.

A further preferred composition according to the invention comprises wheat flour having at least 2 μmol of C-6-phosphate/g of starch and also the baking agent soy flour.

Soy is added as soy flour (=soy powder). Improved water binding is ascribed to soy flour. The addition of soy flour to wheat flour has been studied, inter alia, by Stauffer (2002, American Soybean Association, Europe & Maghreb). They describe a reduction of baking losses by 0.5 to 1.5% on addition of 3 to 5% soy powder to wheat flour.

In this context, the ratio of the individual components to one another can be varied within a relatively large range. Preferably, the amount of soy powder added to the flour is between 0.5 and 10%, in particular between 1 and 5%, and particularly preferably between 1 and 3%.

In a preferred embodiment, the wheat flour according to the invention was genetically modified. In a particularly preferred embodiment the wheat flour of the composition according to the invention was phosphorylated by genetic processes. The phosphate content was thereby increased to at least 2 μmol of C-6-P/g of starch.

In the context of the present invention, “genetically modified wheat flour” means that the wheat flour originates from grains of a genetically modified wheat plant, its genetic modification being a phosphorylation which leads to an increase of the phosphate content of the starch compared with the phosphate content of a corresponding non-genetically modified wheat plant. In non-modified wheat flour, the phosphate in the starch is not detectable at all, or merely in traces.

In a further embodiment, in the composition according to the invention the flour used comprises a mixture of different flours in combination with at least one baking agent in an amount which reduces the synergistic baking loss, this flour mixture having a phosphate content of at least 2 μmol of C-6-P/g of starch.

In a preferred embodiment, it is a mixture of at least one modified flour with at least one non-modified flour.

In a further preferred embodiment, in the composition according to the invention, the flour used is composed of two or more different modified flours.

In a further preferred embodiment, the modified flours are genetically modified flours.

The use of these respective flour mixtures to reduce baking losses is likewise encompassed by the present invention.

Also encompassed is a process for reducing baking losses which comprises using one of these flour mixtures.

The use of flours which are composed of qualitatively different flours is absolutely conventional for baking processes. Depending on the end product, this can be a mixture of (qualitatively) different wheat flours or a mixture of wheat flour with flours or starch from other plants, for example corn starch. Conventionally, the flour mixture is composed for the baker as early as in the cereal mill.

“Baker” is taken to mean in this context any form of an operation which processes flour to form bakery products. “Cereal mill” is taken to mean a mechanically operated milling system in which cereal is processed to flour.

In a further preferred embodiment, the present invention encompasses a process for achieving synergistic effects in the reduction of baking losses. This process comprises using, for baking, wheat flour having a phosphate content of at least 2 μmol of C-6-P/g of starch in combination with at least one baking agent.

In a further embodiment, for the process according to the invention, the baking agent is selected from xanthan, carboxymethyl cellulose, pectin, emulsifiers, carob bean meal, guar seed meal or soy flour.

In a further embodiment, in the process according to the invention the wheat flour used has been phosphorylated.

In a further preferred embodiment, the process according to the invention comprises using a mixture of various genetically modified flours in combination with at least one baking agent. In a particularly preferred embodiment, these flours were phosphorylated by means of genetic engineering processes. In a further preferred embodiment, they are wheat flours.

In a further embodiment, in the present invention the baking loss, as weight loss after the baking process, in baked goods according to the process according to the invention is 1 to 20% less than in baked goods which were produced from non-modified wild-type plant flour using baking agents.

In a further advantageous embodiment, the weight loss is reduced by 1 to 18%, preferably by 2 to 15%, particularly preferably by 2 to 10%, and very particularly preferably by 3 to 8%.

“Weight loss” is taken to mean by those skilled in the art the baking loss on baking due to water vaporization. The weight loss (=baking loss) is based fundamentally on the dough weight and is the ratio of dough weight to bread weight. It is calculated as follows:

$$Baking loss = \frac{dough weight - bread weight}{dough weight} \times 100$$

It has been shown that the weight loss of baked goods made from genetically modified wheat flour with addition of baking agents is lower as a percentage than in baked goods from non-modified wheat flour; this is exhibited most greatly in the case of white pan bread (10.6 to 11.1%).

The process for reducing weight losses which comprises using, for baking, wheat flour having a phosphate content of at least 2 μmol of C-6-P/g of starch in combination with at least one baking agent, is likewise encompassed by the present invention.

In the context of the present invention, the expression “baked goods” is to be taken to mean the broader term for dough pieces which can be in various “states”, that is to say unbaked, prebaked, or end-baked.

Those skilled in the art take an unbaked dough to mean a dough for production of baked goods (for example rolls), which comprises all required ingredients, or already formed dough pieces therefrom which have not yet been baked (unbaked dough pieces). In contrast thereto, a prebaked dough is taken to mean dough pieces which, for better storage or for simplification for the consumer, have run through a first baking operation (which can very well comprise a plurality of steps) at the manufacturer's under defined conditions. For the ultimate completion, a further baking operation by the final consumer is required.

End-baked dough pieces are those which are sold correspondingly freshly baked or are produced by the consumers themselves by a final baking operation of prebaked dough pieces.

The expression “correspondingly” in the context of the present invention means that on comparison of a plurality of articles, the articles of interest which are compared with one another were kept under the same conditions. In this context, the expression “correspondingly” means that the baked goods which are compared with one another were produced and tested under the same conditions. With respect to the flour used, the expression “correspondingly” means that the plants from which the flour used was ultimately obtained were grown under the same cultivation conditions.

The expression “wild-type wheat flour”, in the context of the present invention, means that it is flour which was produced from cereals of non-modified wheat plants (=wild-type wheat plants). These wheat plants serve as starting material for those wheat plants which were genetically modified for their use according to the invention; that is to say their genetic information, apart from the genetic modification introduced which leads to an increase of the phosphate content, corresponds to that of a genetically modified wheat plant.

In a further embodiment, in the process according to the invention the baking loss, as water loss after baking, is 1 to 25% less than in baked goods which were manufactured from non-modified wheat flour using baking agents.

In further advantageous embodiments, the water loss is reduced by 5 to 20%, preferably by 5 to 15%, and particularly preferably by 5 to 10%.

Water loss (% water loss based on the water in the dough), in the context of the present invention, is taken to mean the loss of liquid which had occurred after the baking process.

For the production of dough from genetically modified flour and baking agents or dough from non-modified flour, differing amounts of water were weighed out for the same amount of flour in order finally to obtain the same dough consistency. The dough pieces produced have the same weight, but comprise different amounts of water. The dough consistency was measured using the Farinograph (ICC-Standard 115/1), as described hereinafter in the methods part.

If the above-described weight loss (=baking loss due to water evaporation) is based on the amount of water present in the dough, the actual percentage water loss can be calculated:

$$Water loss ( \% ) = \frac{dough weight - bread weight}{dough water} \times 100$$

Surprisingly, the results show a significant reduction of baking losses; the water loss based on the water present in the dough was, for all baked goods made from modified TAAB wheat flour, lower than in the case of the corresponding wild-type baked goods. The most greatly reduced was the water loss, at 32.8%, in the case of hamburger rolls (buns) compared with 35.3% in the case of the wild type. The same was found with white pan bread: here, the wild type KWB had a water loss of 27%, but the TAAB white pan bread, only 24.9%.

In addition, it was surprisingly found that the baked goods made from the composition according to the invention have increased bread moisture.

Increased bread moisture has a beneficial effect on longer freshness retention and good flavor of the baked good. The bread moisture is dependent on the type of the bakery product and on the baking process. The moisture of the baked goods is calculated after drying as follows:

$$Moisture ( \% ) = \frac{initial weight - end weight}{initial weight} \times 100$$

In the case of the use according to the invention, bread moisture is to be taken to mean the moisture content of the entire baked good, that is to say no distinction is to be made between crumb and crust; the latter obviously has a lower moisture than the crumb. Ideally, the bread moisture is increased by 0.5 to 5%. In a preferred embodiment, the bread moisture is increased by 1 to 5%, particularly preferably by 1.5 to 4%, and very particularly preferably by 1.5 to 3%.

In a further preferred embodiment, in the composition according to the invention, the wheat flour comprises a genetically modified starch.

The expression “genetically modified starch”, in the present invention, means a wheat starch which has been altered with respect to its phosphate content using genetic methods in such a manner that, compared with wheat starch from non-genetically modified wild-type plants, it has an increased phosphate content. For this, the R1 gene from potatoes (Solanum tuberosum) was transformed in wheat (Triticum aestivum) as described in WO 02/034923.

In a further embodiment, the genetically modified starch is altered in such a manner that its phosphate content is 2 to 10 μmol of C-6-phosphate/g of starch. In a preferred embodiment, the starch has a content of 2 to 8 μmol of C-6-phosphate/g of starch, and very particularly preferably 4 to 6 μmol of C-6-phosphate/g of starch.

The method according to the invention further comprises the dough yield being increased by 5 to 25% when the composition according to the invention is used in combination with at least one baking agent, compared with using non-modified wheat flour. Dough yield is taken to mean by those skilled in the art the dough weight based on 100 parts of flour. The dough yield is increased by 1 to 10% compared with the wild-type doughs, preferably by 2 to 8%, and particularly preferably by 3 to 5%.

Surprisingly it has been found that the method according to the invention also comprises the baking yield being increased by 5 to 25% when the composition according to the invention is used, compared with using non-modified wheat flour.

Baking yield, in the context of the present invention, is to be taken to mean the weight of the finished baked goods based on 100 parts of flour. In a further preferred embodiment, the baking yield is increased by 5 to 20%, particularly preferably by 8 to 15%, and very particularly preferably by 10 to 15%.

The greatest increase in baking yield was found for hamburger buns, in this case the yield of TAAB baked goods was 5% higher than that of the wild-type baked goods.

### Material and Methods

In the examples use was made of the following methods. Use can be made of these methods to carry out the process according to the invention, they are specific embodiments of the present invention, but do not restrict the present invention to these methods. It is known to those skilled in the art that they can carry out the invention in an identical manner by modifying the described methods and/or by replacing individual method parts by alternative method parts.

### 1. Plant Material for Production of the Genetically Modified Flour

Use was made of wheat plants (Triticum aestivum) which express an R1 gene (alpha-glucan water dikinase; E.C. 2.7.9.4; EMBL AC: Y09533) from Solanum tuberosum. Production of these plants (vectors used, selection of transgenic plants) is described extensively in the patent application WO02/34923 (in examples 1 and 2). The nucleotide and amino acid sequences of the R1 gene are given in Seq ID No.1 and Seq ID No.2. The transformation proceeded according to the method of Becker et al., 1994, Plant J. 5(2): 229-307.

From these wheat plants (line TAAB-40A-11-8), ripe grains were harvested. These grains, the flour obtained therefrom and also the starch were studied chemically and rheologically. The controls used were wheat plants of the wild-type variety Florida which were grown under the same cultivation conditions.

Growth of Plants:

Seed was planted in the open air after prior vernalization.

The plants used were grown and cultivated as follows:

Plant protection: Before the seed was planted, the seed material was pretreated with imidacloprid (Gaucho®, Bayer) to control insect damage (100 cc/100 kg of seed material). Pre-emergence herbicide: diflufenican (Brodal), 250 cc/ha; post-emergence herbicides: metsulfuron methyl (=sulfonylurea derivative; application: 6.7 g/ha; DuPont) and dicamba (application: 0.12 l/ha); fungicide: epoxiconazole (Allegro, application: 0.85 l/ha).

Fertilization: UREA (NH₂)₂CO: 125 kg/ha to blossom; thereafter 100 kg/ha.

### 2. Production of the Genetically Modified Flour

200 kg of wheat grains of line TAAB 40A-11-8 were ground using a Bühler-Mahlautomat (Gebr. Bühler Maschinenfabrik, Uzwill, Switzerland). 200 kg of wheat grains yielded 140 kg of flour type 550 (yield 70%).

### 3. Starch Extraction

The wheat starch was isolated from the wheat flour using distilled water by means of the Perten-Glutomatic machine (Perten Instruments), as described in ICC-Standard No. 155. The starch was extracted with acetone, air-dried for 2 to 3 days and then ground in a mortar to powder.

### 4. Moisture Measurement

The moisture of the bread sample is determined using a moisturemeter (Sartorius, Göttingen, Germany). The sample is dried at 115° C. until the weight no longer decreases. The calculation proceeds according to the formula:

$$Moisture ( \% ) = \frac{initial weight - end weight}{initial weight} \times 100$$

### 5. Determination of the Starch Phosphate Content in the C6 Position (C6-P Content)

In the starch, positions C3 and C6 of the glucose units can be phosphorylated. To determine the C6-P content of the starch (as described by Nielsen et al., 1994, Plant Physiol. 105: 111-117), 100 mg of wheat starch were hydrolyzed in 500 μl of 0.7 MHCl for 4 h at 95° C. with continuous shaking. Subsequently, the batches were centrifuged for 10 min at 13.000 rpm and the supernatants purified from suspended matter and turbidity by means of a filter membrane (0.45 μM). 20 μl of the clear hydrolyzate were mixed with 180 μl imidazole buffer (300 mM imidazole, pH 7.4; 7.5 mM MgCl₂, 1mM EDTA and 0.4 mM NADP). The measurement was carried out in a photometer at 340 nm. After measurement of the base absorption, the enzyme reaction was started by adding 2 units of glucose-6-phosphate dehydrogenase (from Leuconostoc mesenteroides, Boehringer Mannheim). The change in absorption is based on equimolar reaction of glucose-6-phosphate and NADP to form 6-phosphono-gluconate and NADPH, the formation of NADPH being measured at the abovementioned wavelength. The reaction was followed until a plateau was reached. The result of this measurement is the content of glucose-6-phosphate in the hydrolyzate. From the identical hydrolyzate, on the basis of the content of glucose liberated, the degree of hydrolysis was determined. This is used to relate the content of glucose-6-phosphate to the fraction of hydrolyzed starch from the amount of fresh weight. For this 10 μl of hydrolyzate were neutralized by 10 μl of 0.7M NaOH and subsequently diluted 1:100 with water. 4 μl of this dilution were admixed with 196 μl of measurement buffer (100 mM imidazole pH6.9; 5 mM MgCl₂1 mM ATP, 0.4 mM NADP) and used for determination of the base absorption. The reaction followed was by adding 2 μl of enzyme mix (hexokinase 1:10; glucose-6-phosphate dehydrogenase from yeast 1:10 in measurement buffer) and at 340 nm to the plateau. The measurement principle corresponds to the first reaction.

The result of this measurement gives the amount of glucose (in mg) which was liberated from the starch present in the starting material in the course of hydrolysis.

Subsequently, the results of both measurements are related, in order to express the content of glucose-6-phosphate per mg of hydrolyzed starch. Other than in the case of relating the amount of glucose-6-phosphate to the fresh weight of the sample, by this calculation the amount of glucose-6-phosphate is only based on the part of the starch which was completely hydrolyzed to glucose and thus is also to be considered the source for glucose-6-phosphate.

### 6. Analytical Data of the Flours

The TAAB flour and also the wild-type wheat flour were analyzed by standard methods of the International Association for Cereal Science and Technology (ICC/www.icc.or.at) or of the American Association of Cereal Chemists (AACC/www.aaccnet.org). The standard used in each case is listed in brackets. Since it can be requested on the respective internet page, it will not be described here again. The following parameters were studied:
1. Ash content (ICC Standard 104/1)
2. Protein content (ICC Standard 105/2)
3. Wet gluten content (ICC Standard 137/1)
4. Gluten Index (ICC Standard 155)
5. Sedimentation value (ICC Standard 116/1)
6. Damaged starch (AACC Method 76-31)
7. Falling number (AACC Method 22-08)
8. Farinograph (ICC Standard 115/1)

### 7. Baking Experiments Procedure

The baking experiments were carried out at Bayer BioScience GmbH (Potsdam, Germany) and also at the American Institute of Baking International (=AIBI; Kansas, USA) according to standard methods. Use was made for this not only of flour from genetically modified wheat plants but also flour from wild-type wheat plants as a control.

FIG. 1 shows an overview of the various baking processes which are described hereinafter under 7.1.-7.4.

### Compositions and Methods of the Baking Experiments:

### 7.1 Starter and Dough for White Pan Breads (WPB)

| Ingredients | Baker %* |
|---|---|
| Starter: | |
| Flour | 70.0 |
| Yeast (fresh) | 2.0 |
| Food yeast (without oxidants) | 0.5 |
| Emulsifier SSL (sodium stearoyl | 0.5 |
| lactylate) | |
| Water | 42.0 |
| Dough: | |
| Flour | 30.0 |
| Granulated sugar | 7.0 |
| Baking fat | 3.0 |
| Salt | 2.0 |
| Calcium propionate | 0.25 |
| Water^{a} | variable (17.0) |

^{a}Water is calculated on the basis of 59% of the amount of flour
*Flour is set at 100%, the other components are then added thereto

Mixer: Hobart A-120 Mixer (Hobart Corporation/OH/USA) with McDuffee bowl
and fork kneading attachment
   Starter: Mixing the ingredients for 1 minute at speed 1 (=104 rpm)
Further mixing for 1 minute at speed 1.
Dough temperature after mixing: 26° C.±1° C.
   Fermentation: Fermentation proceeds at 29° C. for 4 hours in a foil-covered vessel
   Dough: The dough ingredients are mixed in a dough bowl for 30 seconds at speed 1 (=104 rpm).
Addition of starter and mixing for a further 30 seconds at speed 1 (=104 rpm)
Mixing the dough at speed 2 (194 rpm) to optimum gluten development (recognizable on squeezing the dough between fingers).
Ideal dough temperature is 26° C.±1° C.
   Proof time: Proofing the dough for 20 minutes at 29° C. in a covered vessel.
   Dividing into 2 loaves per batch (524 g per loaf)
   Intermediate fermentation: Dough pieces (524 g) proof for 10 minutes at room temperature
   Forming: Roller forming machine
Dimensions: top roll: 0.87 cm; bottom roll: 0.67 cm;
Press plate: 3.1 cm; press plate width: 23 cm.
   Fermentation: The formed loaves are placed into bread molds in the fermentation cabinet at 43° C. and 81.5% relative humidity.
The dough should expand up to 1.5 cm above the top rim of the bread mold.
   Baking: 20 minutes at 215° C.
   Bread mold dimensions: Top (inside): 25×10.8 cm (estimated) Bottom (outside): 24.1×7.6 cm.
Depth (inside): 7 cm

### 7.2. Starter and Dough for Hamburger Buns

| Ingredients | Baker %* |
|---|---|
| Starter: | |
| Flour | 70.0 |
| Yeast (fresh) | 3.0 |
| Water | 46.0 |
| Emulsifier SSL (sodium stearoyl | 0.5 |
| lactylate) | |
| Food yeast | 0.3 |
| Dough: | |
| Flour | 30.0 |
| High fructose corn syrup (42%) | 18.0 |
| Baking fat | 6.0 |
| Salt | 2.0 |
| Ascorbic acid | 60 ppm |
| Water | variable |
| Calcium propionate | 0.12 |

*Flour is set at 100%, the other components are then added thereto

Mixer: Hobart A-120 Mixer (Hobart Corporation/OH/USA) with McDuffee bowl and fork kneading attachment
Mixing dough: Mixing the ingredients for 1 minute at speed 1 (104 rpm).
Further mixing for 1 minute at speed 1 (104 rpm).
After mixing the mixing dough should have a temperature of 26° C.±1° C.
   Fermentation: The fermentation proceeds at 29° C. for 3.5 hours in a foil covered vessel
   Bread dough: The dough ingredients are mixed in a mixing bowl for 30 seconds at speed 1 (104 rpm).
Addition of the mixing dough and mixing for a further 30 seconds at speed 1
Mixing the dough at speed 2 (194 rpm) up to optimum gluten development.
Ideal dough temperature is 26° C.±1° C.
   Proof time: Proofing the completely mixed dough for 10 minutes at 29° C. in a covered vessel.
   Intermediate step: Dividing the dough into pieces of 56 g which are brought into a round flat form
   Piece proof: The formed loaves are placed into bread molds and introduced into the fermentation cabinet at 43° C. and 90% relative humidity.
The dough should expand to 3.6 cm.
   Baking: 11 minutes at 224° C.
   Bread dimensions: Weight (g) and volume (cc); measurement proceeds 30 minutes after baking.

### 7.3 Prebaked Frozen Baguettes

| Ingredients | Baker %* |
|---|---|
| Flour | 100 |
| Salt | 2.0 |
| Baking agent | variable |
| ^{a}Water | variable |
| Yeast (fresh) | 2.0 |

^{a}Water as determined by the farinograph (+3%)
*Flour is set at 100%, the other components are then added thereto

Mixer: Spiral mixer (Diosna, 22I—Diosna Dierks & Söhne GmbH, Osnabrück/Germany)
Mix: Two minutes at speed one (100 rpm)
Three minutes at speed two (200 rpm)
Desired dough temperature is 24° C.
   Proof: 20 minutes
   Division: Divide dough into dough pieces of 115 g, round by hand and form into the length
   Piece proof: The formed loaves are placed into baguette molds and fermented in the fermentation cabinet for 90 minutes at 24° C. and 87% relative humidity

### Baking: 30 sec at 240° C.

2.00 min at 210° C.
15.30 min at 200° C.
   During the baking process, the baguettes were sprayed with 80 ml of H₂O.
   Freezing: Prebaked baguettes are frozen at −70° C. for 1 h, thereafter stored in the deep freeze at −18° C.
   Baking out: After storage for one week, the prebaked baguettes are end-baked at 215° C. for 12minutes.

### 7.4 Rolls

| Ingredients | Baker %* |
|---|---|
| Flour | 100 |
| Salt | 2.0 |
| Yeast (fresh) | 6.0 |
| Baking fat | 1.0 |
| Sugar | 1.0 |
| Baking agent | variable |
| Water^{a} | variable |

^{a}Water as determined by the farinograph

Mix: Two minutes at speed one (100 rpm)
Three minutes at speed two (200 rpm).
Desired dough temperature =27° C.
   Proof: 20 minutes
   Scale: The dough is placed onto a forming plate and divided into 30 dough pieces using a dividing and rounding machine
   Piece proof: The forming plate with the divided and formed dough is stored in the fermentation cabinet for 35 minutes at 32° C. and 87% relative humidity

### Baking: 30 sec at 240° C.

2.00 min at 210° C.
15.30 min at 200° C.
   During the baking process the rolls are sprayed with 80 ml of H₂O.

### 8. Calculation for the Synergistic Action of a Combination of Two Active Compounds

The action to be expected (reduction of baking loss) for a given combination of a modified flour with an additive (baking agent) can be calculated as follows (Kaiser 2006, oral communication):

When

x0 expresses the functionality of the standard flour (nontransgenic) without additive and

y0 expresses the functionality of a modified flour,

then the effect of standard flour+baking agent additive z is described by:

X(z) where X(z)=x0 for z=0,

and
modified flour+baking agent additive z is described by:

Y(z) where Y(z)=y0 for z=0.

Those skilled in the art expect an improvement when a modified flour is used compared with standard flour, when the action of modified flour+additive behaves as:

Y′(z)=X(z)+y0−x0

There is a synergistic effect when: Y(z) is greater than Y′(z).

Here it is expected that max {Y(z): z>0}>max{X(z): z>0}, a still better effect when:

max{Y(z): z>0}−max{X(z): z>0}>y0−x0.

Equally, a synergistic effect can also be indicated by an effect increased markedly earlier with smaller addition of baking agent, that is to say when the following applies

Y(z′)>=X(z)−x0+y0 for a z′ where 0<z′<z

### EXAMPLES

### Example 1

### Production of Genetically Modified Wheat Plants

The vector pUbiR1 which was used for transformation of the wheat plants was produced as described in WO 02/034923 (example 1). Likewise, in WO 02/034923 (example 2) production is described of the genetically modified wheat plants which carry the R1 gene from potatoes (Solanum tuberosum).

For the process according to the invention, genetically modified wheat plants of line TAAB 40A-11-8 were used. Seed material of this line and also of the unmodified wheat “Florida” (hereinafter termed “wild type”) was planted as seed in Argentina and harvested.

### Example 2

### Compilation of the Properties of Wheat Flour of the Genetically Modified Line Compared with Unmodified Flour

Analysis of the wheat flours was performed according to standard methods of the ICC or of the American Association of Cereal Chemists (AACC). The following parameters were studied:
1. Ash content (ICC 104/1)
2. Protein content (ICC 105/2)
3. Wet gluten content (ICC 137/1)
4. Gluten index (ICC 155)
5. Sedimentation value (ICC 116/1)
6. Damaged starch (AACC 76-31)
7. Falling number (AACC 22-08)
8. Farinograph (ICC 115/1)

TABLE 1
Analytical data of the flours:

| Parameter | Wild type | TAAB 40A-11-8 |
|---|---|---|
| Ash content (%) | 0.56 | 0.58 |
| Protein % (Kjeldahl) | 13.8 | 14.5 |
| Wet gluten content (%) | 31 | 33 |
| Gluten index (%) | 80 | 76 |
| Sedimentation value (ml) | 38 | 39 |
| Damaged starch (%) | 5 | 5.6 |
| Falling number (s) | 418 | 451 |
| Farinograph: | | |
| Water absorption (%) | 58 | 62 |
| Dough development time (min) | 6 | 6.5 |
| Dough stability (min) | 10 | 11 |

Comparison of the analytical data shows that the modified TAAB flour, with retention of quality parameters, had a higher water absorption value than the unmodified wild-type flour.

### Example 3

### Compilation of the Properties of Wheat Starch of the Genetically Modified Line Compared with Wild Type

TABLE 2
Properties of the wheat starches: compilation of the parameters
and results described in WO02/034923

| Line | Wild type | TAAB 40A-11-8 |
|---|---|---|
| C-6-P in nmol/mg of starch | Not detectable | 5.0 |
| RVA | 100% | 124% |
| Max | | |
| Min | 100% | 132% |
| Fin | 100% | 135% |
| T | 100% | 97% |
| Gel strength | 100% | 164% |
| DSC | 64° C. | 61° C. |
| Tpeak | | |
| Tonset | 58° C. | 56° C. |

### Example 4

### Results of the Baking Experiments

TABLE 3
Weight losses and liquid losses and also yields of various baking
products after baking using baking agent (emulsifier SSL 0.5%)

| | WPB | | Buns | |
|---|---|---|---|---|
| | TAAB | WT | TAAB | WT |
| Weight loss % | 10.6 | 11.1 | 13.0 | 13.2 |
| Water loss/Water in | 24.9 | 27.0 | 32.8 | 36.3 |
| dough % | | | | |
| Bread moisture % | 35.7 | 33.9 | 27.9 | 25.5 |
| Bread moisture/volume | 71 | 66 | 56 | 49 |
| (mg/ml) | | | | |
| Dough yield % | 176.3 | 172.0 | 178.9 | 174.9 |
| Baked yield (%) | 154.7 | 150.6 | 155.6 | 150.6 |

Comparison of the products of genetically modified (TAAB) and unmodified wheat flour (WT). WPB=white pan bread/buns=hamburger buns.

Baking loss is the weight loss during baking owing to water evaporation. The baking loss in percent is fundamentally based on the dough weight, it is calculated as follows:

$$Baking loss ( \% ) = \frac{dough weight - bread weight}{dough weight} \times 100$$

The results show that the weight loss of the bakery products from modified wheat flour is lower as a percentage than with the wild type.

Relating the weight loss to the amount of water present in the dough, the actual water loss can be calculated:

$$Water loss ( \% ) = \frac{dough weight - bread weight}{dough water} \times 100$$

The water loss is calculated from the height of water addition which is different from the different flours and their water binding capacity in order to obtain the same dough consistency. The liquid loss of the bakery products of modified wheat flour is also less than that of the bakery products which were produced from unmodified flour.

The bread moisture based on the volume for all bakery products made from modified wheat flour was significantly higher than with the bakery products from unmodified wheat flour. The increased bread moisture has a beneficial effect on improved freshness retention of bakery products (extended shelf life).

The moisture was calculated as follows:

$$Moisture ( \% ) = \frac{initial weight - end weight}{initial weight} \times 100$$

1. A composition comprising wheat flour having a phosphorylated starch and a phosphate content of at least 2 μmol of C-6-P/g of starch and at least one baking agent, wherein said composition reduces baking loss more than compositions which comprise wheat flour having a phosphate content of less than 2 μmol of C-6-P/g of starch.

2. The composition as claimed in claim 1, wherein the combination of said wheat flour and baking agent reduce baking loss synergistically.

3. The composition as claimed in claim 1, wherein the baking agent is xanthan, carboxymethyl cellulose, pectin, carob bean meal, emulsifiers, guar seed meal, or soy flour.

4. The composition as claimed in claim 1, wherein the baking agent is xanthan.

5. The composition as claimed in claim 1, wherein the baking agent is carboxymethyl cellulose.

6. The composition as claimed in claim 1, wherein the baking agent is pectin.

7. The composition as claimed in claim 1, wherein the baking agent is carob bean meal.

8. The composition as claimed in claim 1, wherein the baking agent is an emulsifier.

9. The composition as claimed in claim 1, wherein the baking agent is a guar seed meal.

10. The composition as claimed in claim 1, wherein the phosphorylated starch of the wheat flour is derived from a genetically engineered wheat.

11. (canceled)

12. A process for reducing baking loss comprising combining wheat flour having a phosphorylated starch and a phosphate content of at least 2 μmol of C-6-P/g of starch with at least one baking agent.

13. The process as claimed in claim 12, wherein the baking agent is xanthan, carboxymethyl cellulose, pectin, emulsifier, carob bean meal, guar seed meal, or soy flour.

14. The process as claimed in claim 12, wherein the phosphorylated starch of the wheat flour is derived from a genetically engineered wheat.

15. The process as claimed in claim 14, further comprising baking said dough to make a baked good, wherein the baking loss from water loss after baking in baked goods made from wheat flour having phosphorylated starch and a phosphate content of at least 2 μmol of C-6-P/g of starch is 10-20% less than in baked goods which were produced from wheat flour having a phosphate content of less than 2 μmol of C-6-P/g of starch.

16. The process as claimed in claim 12, further comprising combining said wheat flour and baking agent with water to make a dough.


SEQUENCE LISTING (2 sequences)

SEQ ID NO: 1 - DNA, 4851 bp, Solanum tuberosum
  CDS (105)..(4499)
  ref <308>: DATABASE ACCESSION NUMBER: EMBL / Y09533
  ref <309>: DATABASE ENTRY DATE: 1998-07-30
  ref <313>: RELEVANT RESIDUES IN SEQ ID NO: (105)..(4499)
catcttcatcgaatttctcgaagcttcttcgctaatttcctggtttcttcactcaaaatcgacgtttctagctgaacttgagtgaattaagccagtgggaggatatgagtaattccttagggaataacttgctgtaccagggattcctaacctcaacagtgttggaacataaaagtagaatcagtcctccttgtgttggaggcaattctttgtttcaacaacaagtgatctcgaaatcacctttatcaactgagtttcgaggtaacaggttaaaggtgcagaaaaagaaaatacctatggaaaagaagcgtgctttttctagttctcctcatgctgtacttaccactgatacctcttctgagctagcagaaaagttcagtctaggggggaatattgagctacaggttgatgttaggcctcccacttcaggtgatgtgtcctttgtggattttcaagtaacaaatggtagtgataaactgtttttgcactggggggcagtaaaattcgggaaagaaacatggtctcttccgaatgatcgtccagatgggaccaaagtgtacaagaacaaagcacttagaactccatttgttaaatctggctctaactccatcctgagactggagatacgagacactgctatcgaagctattgagtttctcatatacgatgaagcccacgataaatggataaagaataatggtggtaattttcgtgtcaaattgtcaagaaaagagatacgaggcccagatgtttctgttcctgaggagcttgtacagatccaatcatatttgaggtgggagaggaagggaaaacagaattacccccctgagaaagagaaggaggaatatgaggctgctcgaactgtgctacaggaggaaatagctcgtggtgcttccatacaggacattcgagcaaggctaacaaaaactaatgataaaagtcaaagcaaagaagagcctcttcatgtaacaaagagtgatatacctgatgaccttgcccaagcacaagcttacattaggtgggagaaagcaggaaagccgaactatcctccagaaaagcaaattgaagaactcgaagaagcaagaagagaattgcaacttgagcttgagaaaggcattacccttgatgagttgcggaaaacgattacaaaaggggagataaaaactaaggtggaaaagcacctgaaaagaagttcttttgccgttgaaagaatccaaagaaagaagagagactttgggcatcttattaataagtatacttccagtcctgcagtacaagtacaaaaggtcttggaagaaccaccagccttatctaaaattaagctgtatgccaaggagaaggaggagcagattgatgatccgatcctaaataaaaagatctttaaggtcgatgatggggagctactggtactggtagcaaagtcctctgggaagacaaaagtacatctagctacagatctgaatcagccaattactcttcactgggcattatccaaaagtcctggagagtggatggtaccaccttcaagcatattgcctcctgggtcaattattttagacaaggctgccgaaacacctttttcagccagttcttctgatggtctaacttctaaggtacaatctttggatatagtaattgaagatggcaattttgtggggatgccatttgttcttttgtctggtgaaaaatggattaagaaccaagggtcggatttctatgttggcttcagtgctgcatccaaattagcactcaaggctgctggggatggcagtggaactgcaaagtctttactggataaaatagcagatatggaaagtgaggctcagaagtcatttatgcaccggtttaatattgcagctgacttgatagaagatgccactagtgctggtgaacttggttttgctggaattcttgtatggatgaggttcatggctacaaggcaactgatatggaacaaaaactataacgtaaaaccacgtgaaataagcaaggctcaggacagacttacagacttgttgcagaatgctttcaccagtcaccctcagtaccgtgaaattttgcggatgattatgtcaactgttggacgtggaggtgaaggggatgtaggacagcgaattagggatgaaattttggtcatccagaggaacaatgactgcaagggtggtatgatgcaagaatggcatcagaaattgcataataatactagtcctgatgatgttgtgatctgtcaggcattaattgactacatcaagagtgattttgatcttggtgtttattggaaaaccctgaatgagaacggaataacaaaagagcgtcttttgagttatgaccgtgctatccattctgaaccaaattttagaggagatcaaaagggtggtcttttgcgtgatttaggtcactatatgagaacattgaaggcagttcattcaggtgcagatcttgagtctgctattgcaaactgcatgggctacaaaactgagggagaaggctttatggttggagtccagataaatcctgtatcaggcttgccatctggctttcaggacctcctccattttgtcttagaccatgtggaagataaaaatgtggaaactcttcttgagagattgctagaggctcgtgaggagcttaggcccttgcttctcaaaccaaacaaccgtctaaaggatctgctgtttttggacatagcacttgattctacagttagaacagcagtagaaaggggatatgaagaattgaacaacgctaatcctgagaaaatcatgtacttcatctccctcgttcttgaaaatctcgcactctctgtggacgataatgaagatcttgtttattgcttgaagggatggaatcaagctctttcaatgtccaatggtggggacaaccattgggctttatttgcaaaagctgtgcttgacagaacccgtcttgcacttgcaagcaaggcagagtggtaccatcacttattgcagccatctgccgaatatctaggatcaatacttggggtggaccaatgggctttgaacatatttactgaagaaattatacgtgctggatcagcagcttcattatcctctcttcttaatagactcgatcccgtgcttcggaaaactgcaaatctaggaagttggcagattatcagtccagttgaagccgttggatatgttgtcgttgtggatgagttgctttcagttcagaatgaaatctacgagaagcccacgatcttagtagcaaaatctgttaaaggagaggaggaaattcctgatggtgctgttgccctgataacaccagacatgccagatgttctttcacatgtttctgttcgagctagaaatgggaaggtttgctttgctacatgctttgatcccaatatattggctgacctccaagcaaaggaaggaaggattttgctcttaaagcctacaccttcagacataatctatagtgaggtgaatgagattgagctccaaagttcaagtaacttggtagaagctgaaacttcagcaacacttagattggtgaaaaagcaatttggtggttgttacgcaatatcagcagatgaattcacaagtgaaatggttggagctaaatcacgtaatattgcatatctgaaaggaaaagtgccttcctcggtgggaattcctacgtcagtagctcttccatttggagtctttgagaaagtactttcagacgacataaatcagggagtggcaaaagagttgcaaattctgatgaaaaaactatctgaaggagacttcagcgctcttggtgaaattcgcacaacggttttagatctttcagcaccagctcaattggtcaaagagctgaaggagaagatgcagggttctggcatgccttggcctggtgatgaaggtccaaagcggtgggaacaagcatggatggccataaaaaaggtgtgggcttcaaaatggaatgagagagcatacttcagcacaaggaaggtgaaactggatcatgactatctgtgcatggctgtccttgttcaagaaataataaatgctgattatgcatttgtcattcacacaaccaacccatcttccggagacgactcagaaatatatgccgaggtggtcaggggccttggggaaacacttgttggagcttatccaggacgtgctttgagttttatctgcaagaaaaaggatctcaactctcctcaagtgttaggttacccaagcaaaccgatcggccttttcataaaaagatctatcatcttccgatctgattccaatggggaagatttggaaggttatgccggtgctggcctctacgacagtgtaccaatggatgaggaggaaaaagttgtaattgattactcttccgacccattgataactgatggtaacttccgccagacaatcctgtccaacattgctcgtgctggacatgctatcgaggagctatatggctctcctcaagacattgagggtgtagtgagggatggaaagatttatgtcgttcagacaagaccacagatgtgattatattctcgttgtatgttgttcagagaagaccacagatgtgatcatattctcattgtatcagatctgtgaccacttacctgatacctcccatgaagttacctgtatgattatacgtgatccaaagccatcacatcatgttcaccttcagctattggaggagaagtgagaagtaggaattgcaatatgaggaataataagaaaaactttgtaaaagctaaattagctgggtatgatatagggagaaatgtgtaaacattgtactatatatagtatatacacacgcattatgtattgcattatgcactgaataatatcgcagcatcaaagaagaaatcctttgggtggtttc

SEQ ID NO: 2 - protein, 1464 aa, Solanum tuberosum
MSNSLGNNLLYQGFLTSTVLEHKSRISPPCVGGNSLFQQQVISKSPLSTEFRGNRLKVQKKKIPMEKKRAFSSSPHAVLTTDTSSELAEKFSLGGNIELQVDVRPPTSGDVSFVDFQVTNGSDKLFLHWGAVKFGKETWSLPNDRPDGTKVYKNKALRTPFVKSGSNSILRLEIRDTAIEAIEFLIYDEAHDKWIKNNGGNFRVKLSRKEIRGPDVSVPEELVQIQSYLRWERKGKQNYPPEKEKEEYEAARTVLQEEIARGASIQDIRARLTKTNDKSQSKEEPLHVTKSDIPDDLAQAQAYIRWEKAGKPNYPPEKQIEELEEARRELQLELEKGITLDELRKTITKGEIKTKVEKHLKRSSFAVERIQRKKRDFGHLINKYTSSPAVQVQKVLEEPPALSKIKLYAKEKEEQIDDPILNKKIFKVDDGELLVLVAKSSGKTKVHLATDLNQPITLHWALSKSPGEWMVPPSSILPPGSIILDKAAETPFSASSSDGLTSKVQSLDIVIEDGNFVGMPFVLLSGEKWIKNQGSDFYVGFSAASKLALKAAGDGSGTAKSLLDKIADMESEAQKSFMHRFNIAADLIEDATSAGELGFAGILVWMRFMATRQLIWNKNYNVKPREISKAQDRLTDLLQNAFTSHPQYREILRMIMSTVGRGGEGDVGQRIRDEILVIQRNNDCKGGMMQEWHQKLHNNTSPDDVVICQALIDYIKSDFDLGVYWKTLNENGITKERLLSYDRAIHSEPNFRGDQKGGLLRDLGHYMRTLKAVHSGADLESAIANCMGYKTEGEGFMVGVQINPVSGLPSGFQDLLHFVLDHVEDKNVETLLERLLEAREELRPLLLKPNNRLKDLLFLDIALDSTVRTAVERGYEELNNANPEKIMYFISLVLENLALSVDDNEDLVYCLKGWNQALSMSNGGDNHWALFAKAVLDRTRLALASKAEWYHHLLQPSAEYLGSILGVDQWALNIFTEEIIRAGSAASLSSLLNRLDPVLRKTANLGSWQIISPVEAVGYVVVVDELLSVQNEIYEKPTILVAKSVKGEEEIPDGAVALITPDMPDVLSHVSVRARNGKVCFATCFDPNILADLQAKEGRILLLKPTPSDIIYSEVNEIELQSSSNLVEAETSATLRLVKKQFGGCYAISADEFTSEMVGAKSRNIAYLKGKVPSSVGIPTSVALPFGVFEKVLSDDINQGVAKELQILMKKLSEGDFSALGEIRTTVLDLSAPAQLVKELKEKMQGSGMPWPGDEGPKRWEQAWMAIKKVWASKWNERAYFSTRKVKLDHDYLCMAVLVQEIINADYAFVIHTTNPSSGDDSEIYAEVVRGLGETLVGAYPGRALSFICKKKDLNSPQVLGYPSKPIGLFIKRSIIFRSDSNGEDLEGYAGAGLYDSVPMDEEEKVVIDYSSDPLITDGNFRQTILSNIARAGHAIEELYGSPQDIEGVVRDGKIYVVQTRPQM